(19) United States
(12) Patent Application Publication
(10) Pub. No.: US 2022/0284150 A1
(43) Pub. Date: Sep. 8, 2022

(54) Dynamic Progressive Failure Analysis Method For Composite Multi-Scale Model

(71) Applicant: Nanjing University Of Aeronautics And Astronautics, Nanjing (CN)

(72) Inventors: Zhenchao Qi, Nanjing (CN); Yong Liu, Nanjing (CN); Xingxing Wang, Nanjing (CN); Wenliang Chen, Nanjing (CN); Yexin Xiao, Nanjing (CN); Zhenchao QI, Nanjing (CN); Chenxi Yao, Nanjing (CN); Fengchen Li, Nanjing (CN); Ziqin Zhang, Nanjing (CN)

(73) Assignee: Nanjing University Of Aeronautics And Astronautics, Nanjing (CN)

(21) Appl. No.: 17/595,100

(22) PCT Filed: Jul. 16, 2020
(86) PCT No.: PCT/CN2020/102477

§ 371 Date: May 24, 2022

(51) Int. Cl. G06F 30/17; G01N 3/06; B32B 15/08

(52) U.S. Cl. CPC G06F 30/17; G01N 3/066; B32B 15/08

(57) ABSTRACT

This patent studies a scale-span modeling method to simulate the structural mechanical responses and dynamic progressive failure behaviors of carbon fiber reinforced plastics (CFRPs) in drilling. Firstly, considering the different mechanical behaviors of fiber and matrix in micro state, a three-dimensional multi-scale dynamic progressive damage evolution model based on micro failure theory is proposed. Based on the degradation elastic parameters of microcomponent in typical volume element model, a new damage evolution model of fiber and resin matrix and an auxiliary deletion criterion of failure element are proposed. Secondly, the relationship between the macro stress and the micro stress of representative volume element in the composite model is established by using the stress amplification factor. Combined with the bilinear cohesion element model, the damage behavior of the composite in and between layers under the cutting action of dagger drill is simulated.

### TECHNICAL FIELD

The invention relates to the field of mechanical response and progressive damage generated under dynamic load conditions of a composite material laminated plate structure.

### BACKGROUND

In order to reduce damage to the composite structure under dynamic loading conditions, the traditional and simple and direct research method relies on experimental analysis, but the traditional method still has a lot of shortcomings, such as long preparation time, large material consumption, The cost is higher, and more importantly, it is impossible to observe and understand the mechanism of mechanical processing deformation and material failure from the microscopic view.

### SUMMARY

The present invention provides a three-dimensional multi-scale dynamic progressive damage evolution model based on micro-failure criteria. The relationship between macro-stress and micro-stress is established by using stress amplification coefficients, and the structure analysis of composite laminates is converted from macro-scale to micro-scale. Then, the three-dimensional damage constitutive relationship and damage evolution analysis of the composite material are established. By introducing the damage variables of the component failure, the material stiffness is gradually degraded, and the failure and delamination behavior of the composite materials under dynamic loading conditions are simulated. Based on the composite material samples of the same ply sequence method, the model was verified under the dynamic load condition and the process parameters, and the composite (hole wall surface morphology, import and export delamination damage, etc.) Evaluate the machining behavior of materials to realize precision machining.

The multi-scale analysis method proposed in this application is based on the macro-micro mechanical failure theory of composite materials. The core of the method is to establish the macro-micro structure relationship between the components in the composite material through the macro-micro mechanical interaction analysis theory. The damage and failure behavior of each component structure under the action of external load. According to FIG. 1, the multi-scale analysis method is mainly divided into the following three steps.

Step (1): The components of CFRPs are simplified as idealized multi-directional pre-set lay-up sequence structure which includes multilayer UD-CFRPs. It is assumed that the structure of multi-directional CFRPs (MD-CFRPs) is flawless and that the fibers and matrix are tightly bonded during curing. Some minor defects in the material are overlook, such as voids and micro-crack. Meanwhile, the drilling bit FE model is also required to be established according to the actual drilling conditions.

Step (2): The corresponding RVE model is also established based on the basic parameter of CFRPs, such as the diameter of the filament fiber and the fiber volume fraction of CFRPs, etc. The stress-strain relationship of the damage element of the macroscopic FE model of CFRPs will be transferred to the RVE model via SAFs when the bit is in contact with CFRPs. These elements of fiber and matrix in RVE model will be secondary analyzed based on MMF criterion of CFRPs, including element failure judgement, stiffness degradation and deletion, etc. In addition, if the elements are not deleted in the current increment, the element with reduced stiffness will be homogenized in macroscopic drilling FE model, and the macroscopic elastic properties of elements are characterized by the scale-span prediction method, which is used for analysis in the next iteration step.

Step (3): The macroscopic elastic properties of elements which have different degrees of damage will be assigned to the corresponding macroscopic elements with different lay-up sequence structure of CFRPs. Then, the next iteration analysis of the macroscopic drilling FE model will be carried out, and the scale-span simulation process of drilling CFRPs will be end if the pre-set increments is reached.

### BRIEF DESCRIPTION OF THE DRAWINGS:

FIG. 1 Scale-span FE drilling schematic diagram.

FIG. 2 RVE model and the responding reference points in fiber and matrix constituents.

FIG. 3 The stress-strain behavior in fiber and matrix tension and compression cases.

FIG. 4 Schematic diagram of element characteristic length calculation and fiber failure state.

FIG. 5 Numerical algorithm flowchart of VUMAT for Span-scale model in ABAQUS/Explicit.

FIG. 6 Schematic diagram of bilinear cohesive model .

FIG. 7 ABAQUS-Python code script flowchart for calculating the SAFs in RVE.

FIG. 8 Schematic diagram of the layered failure model of the cohesion unit.

FIG. 9 Schematic diagram of periodic boundary condition loading of representative volume element model.

FIG. 10 SAFs of the reference points in fiber.

FIG. 11 SAFs of the reference points in matrix.

FIG. 12 Schematic of the experimental setup for thrust force in the drilling of CFRPs.

FIG. 13 Setup showing the Span-scale model of drilling CFRPs.

FIG. 14 Comparison of the thrust force and torque.

FIG. 15 Comparison of hole's surface morphology.

FIG. 16 Comparison of damage morphology at drill entry and exit.

FIG. 17 Comparison of the delamination factor and deviation.

### DETAILED DESCRIPTION:

The macroscopic stress of the composite laminate structure and the microscopic stress of each component structure are bridged by the stress amplification factor, and the stress amplification factor can be obtained by the finite element analysis result of the representative volume element containing the fiber and the matrix. After the stress amplification factor is obtained, the macro-micro conversion equation is used to realize the conversion of macro-stress to micro-stress. The expression of the macro-micro conversion equation is shown in formulas (1), (2), (3).

$${σ}_{i} = {M}_{σ}^{p k ( n )} {\overline{σ}}_{j} \qquad ( 10 )$$

$$\{ \begin{matrix}{σ}_{i} = {[ {σ}_{1} {σ}_{2} {σ}_{3} {σ}_{4} {σ}_{5} {σ}_{6} ]}^{T} \\ {\overline{σ}}_{j} = {[ {\overline{σ}}_{1} {\overline{σ}}_{2} {\overline{σ}}_{3} {\overline{σ}}_{4} {\overline{σ}}_{5} {\overline{σ}}_{6} ]}^{T}\end{matrix} \qquad ( 11 )$$

$${M}_{σ}^{p k ( n )} = {[ \begin{matrix}{M}_{σ}^{11} & {M}_{σ}^{12} & {M}_{σ}^{13} & {M}_{σ}^{14} & {M}_{σ}^{15} & {M}_{σ}^{16} \\ {M}_{σ}^{21} & {M}_{σ}^{22} & {M}_{σ}^{23} & {M}_{σ}^{24} & {M}_{σ}^{25} & {M}_{σ}^{26} \\ {M}_{σ}^{31} & {M}_{σ}^{32} & {M}_{σ}^{33} & {M}_{σ}^{33} & {M}_{σ}^{34} & {M}_{σ}^{35} \\ {M}_{σ}^{41} & {M}_{σ}^{42} & {M}_{σ}^{43} & {M}_{σ}^{44} & {M}_{σ}^{45} & {M}_{σ}^{46} \\ {M}_{σ}^{51} & {M}_{σ}^{52} & {M}_{σ}^{53} & {M}_{σ}^{54} & {M}_{σ}^{55} & {M}_{σ}^{56} \\ {M}_{σ}^{61} & {M}_{σ}^{62} & {M}_{σ}^{63} & {M}_{σ}^{64} & {M}_{σ}^{65} & {M}_{σ}^{66}\end{matrix} ]}^{( i )} \qquad ( 12 )$$

Where in Eq. (1)-(3), σᵢ denotes the microscopic stress at point n of fiber or matrix, n denotes the number of the pre-set reference point, i=1˜6. σ̅ⱼ denotes the macroscopic stress of CFRPs laminate, j=1˜6. M_{σ}^{pk(n)} denotes the SAFs at point n under the mechanical loading, which establish the relationship between the macroscopic and microscopic levels, can be computed by RVE. p=1˜6, k=1˜6.

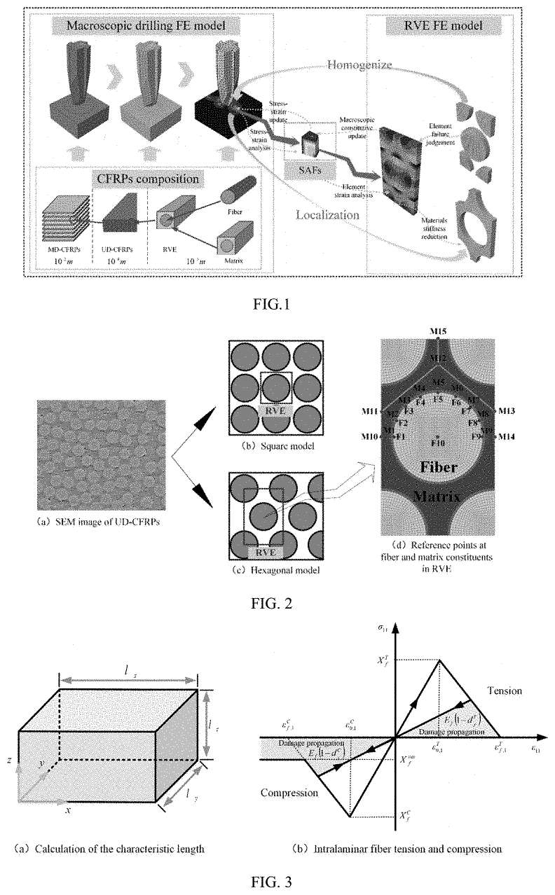

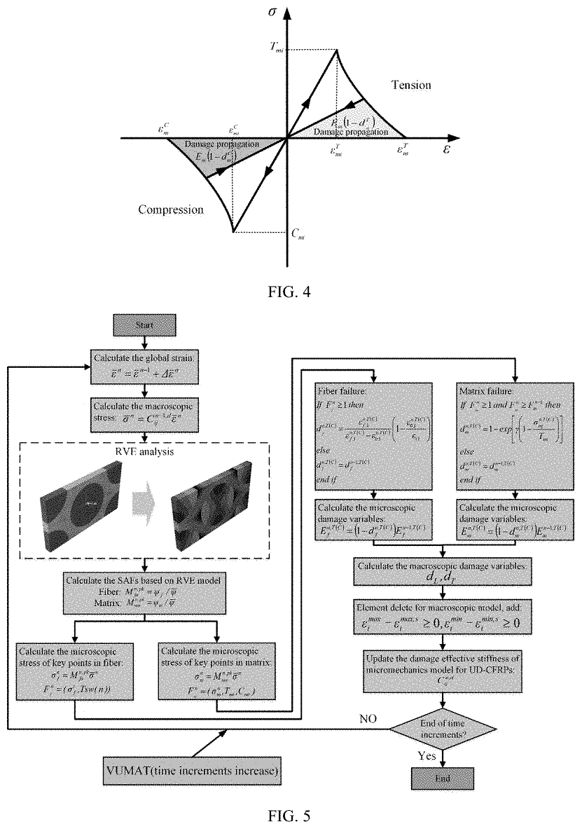

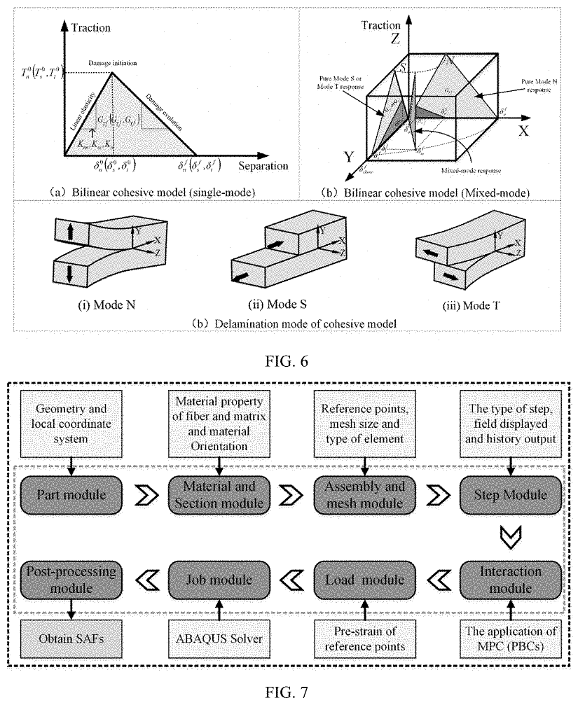

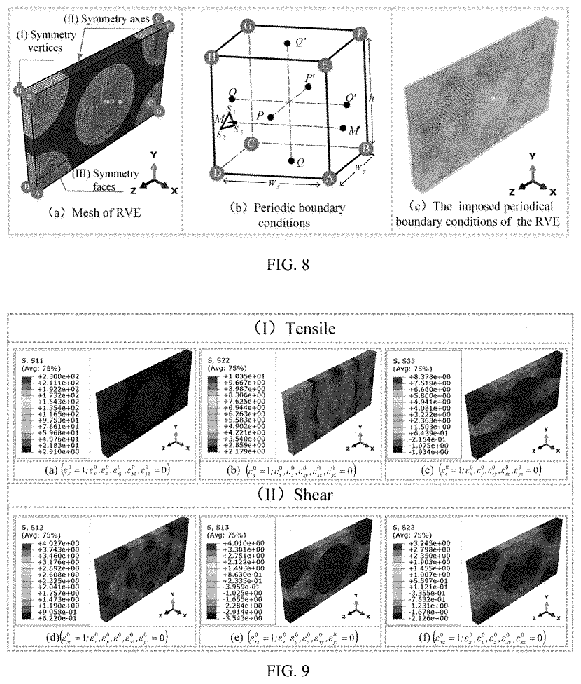

Based on the failure theory of micromechanics, by setting some reference points to the representative volume element model, the stress amplification factor method is used to extract the microscopic stress of the fiber and the matrix. As shown in FIG. 2, according to the observation of the interface of the unidirectional composite laminate by the ultra-depth-of-field electron microscope, the staggered arrangement of the representative volume unit model of the rectangular structure is closer to the random distribution of fibers, and the rectangular model (FIG. 2c) Compared with the square representative volume unit model (FIG. 2b), it is more accurate, so this application will use the rectangular representative volume unit model for analysis.

Load periodic boundary conditions on the representative volume element model, where the displacement relationship of each pair of nodes on the opposite surface in the representative volume element model satisfies formulas (4):

uᵢ^{j+}(x, y, z)−uᵢ^{j-}(x, y, z)=cᵢ^{j}(i, j=1,2,3) (13)

In formula (4): uᵢ^{j+}(x, y, z), uᵢ^{j-}(x, y, z) respectively represent the displacement of nodes in the x, y, and z planes along the j-direction normal vector boundary surface in the i direction of the representative volume element model; the superscripts “+” and “−” represent opposite edges Node pairs on the interface; cᵢ^{j} is the difference in the displacement of the node pairs in the i direction relative to the boundary surface, which is mainly determined by the average strain of the representative volume element; assuming that the average strain of the representative volume element has been determined, cᵢ^{j} changes Constant.

The representative key points for selecting the structure of each component in the representative volume element model are shown in FIG. 2. Among them, the fiber selects 10 reference points (F1˜F10), and the matrix selects 15 reference points (M1-M15).

M_{σ}^{pk(n)} is obtained through the key reference points set in the linear finite element analysis in the representative volume element model, and the obtained equation is:

$${M}_{σ}^{p k ( i )} = ψ / \overline{ψ} \qquad ( 5 )$$

$$\{ \begin{matrix}ψ = {[ \begin{matrix}{ζ}_{1} & {ζ}_{2} & {ζ}_{3} & {ζ}_{4} & {ζ}_{5} & {ζ}_{6}\end{matrix} ]}_{6 \times 6} \\ \overline{ψ} = {[ \begin{matrix}{\overline{ζ}}_{1} & {\overline{ζ}}_{2} & {\overline{ζ}}_{3} & {\overline{ζ}}_{4} & {\overline{ζ}}_{5} & {\overline{ζ}}_{6}\end{matrix} ]}_{6 \times 6}\end{matrix} \qquad ( 6 )$$

Where ξᵢ (i=1,2,3,4,5,6) denote the microscopic stress arrays of each reference points under six macroscopic stress load cases, and ξ̅ᵢ (i=1,2,3,4,5,6) denote the six macroscopic uniform stress load cases.

Meanwhile, ξᵢ and ξ̅ᵢ are assigned as follows:

$${ζ}_{i} = [ \begin{matrix}{σ}_{11} \\ {σ}_{22} \\ {σ}_{33} \\ {σ}_{12} \\ {σ}_{23} \\ {σ}_{13}\end{matrix} ] {\overline{ζ}}_{i} = [ \begin{matrix}{\overline{σ}}_{11} \\ {\overline{σ}}_{22} \\ {\overline{σ}}_{33} \\ {\overline{σ}}_{12} \\ {\overline{σ}}_{23} \\ {\overline{σ}}_{13}\end{matrix} ] i = 1 , 2 , 3 , 4 , 5 , 6 \qquad ( 7 )$$

Where σᵢ (i=11, 22, 33, 12, 23, 13) denotes the obtained microscopic stress of the RVE model under six macroscopic stress load cases, and σ̅ᵢ (i=11, 22, 33, 12, 23, 13) denotes the loaded six macroscopic uniform stress load cases. 11, 22, 33, 12, 23, 13 denote three uniaxial tensile along X, Y, Z direction and the macroscopic shear along Z, X, Y plane, respectively, which is shown in Error! Reference source not found. Taking X direction tensile for example, macroscopic stress ξ̅ᵢ equals to [1 0 0 0 0 0]^{T}. The microscopic stress could be extracted from the reference points in RVE model under the unit stress in six load cases, and the SAFs in X direction are easy to be obtained from the microscopic stresses with Eq. (5). Similarly, the analogous approach is adopted to obtain the SAFs for other load cases.

Due to it is 3D solid element, the equation involves six stress components, which is written as follows:

f₁σ₁+f₂σ₂+f₃σ₃+f₁₁σ₁²+f₂₂σ₂²+f₃₃σ₃²+2 f₁₂σ₁σ₂+2 f₂₃σ₂σ₃+2 f₁₃σ₃σ₁+f₄₄σ₄²+f₅₅σ₅²+f₆₆σ₆²=1 (8)

Where fᵢ and fᵢⱼ denote the strength tensor in i direction and ij plane, respectively. i,j=1,2,3 (i denotes fiber longitudinal direction). σᵢ denote the microscopic normal stress of fiber. In addition, the equation of each strength tensor could be written by

$$\{ \begin{matrix}{f}_{1} = \frac{1}{{X}_{f}^{T}} - \frac{1}{{X}_{f}^{C}} ; {f}_{2} = \frac{1}{{Y}_{f}^{T}} - \frac{1}{{Y}_{f}^{C}} ; {f}_{3} = \frac{1}{{Z}_{f}^{T}} - \frac{1}{{Z}_{f}^{C}} \\ {f}_{11} = \frac{1}{{X}_{f}^{T} {X}_{f}^{C}} ; {f}_{22} = \frac{1}{{Y}_{f}^{T} {Y}_{f}^{C}} ; {f}_{33} = \frac{1}{{Z}_{f}^{T} {Z}_{f}^{C}} \\ {f}_{44} = \frac{1}{{( {S}_{f}^{Y Z} )}^{2}} ; {f}_{55} = \frac{1}{{( {S}_{f}^{X Z} )}^{2}} ; {f}_{66} = \frac{1}{{( {S}_{f}^{X Y} )}^{2}} \\ \begin{matrix}{f}_{12} = \frac{- 1}{2 \sqrt{{X}_{f}^{T} {X}_{f}^{C} {X}_{f}^{T} {X}_{f}^{C}}} ; {f}_{23} = \frac{- 1}{2 \sqrt{{Y}_{f}^{T} {Y}_{f}^{C} {Y}_{f}^{T} {Y}_{f}^{C}}} ; \\ {f}_{13} = \frac{- 1}{2 \sqrt{{Z}_{f}^{T} {Z}_{f}^{C} {X}_{f}^{T} {X}_{f}^{C}}}\end{matrix}\end{matrix} \qquad ( 9 )$$

Where X, Y and Z denote the failure strength in each direction, respectively. The superscripts T and C denote tensile and compressible conditions, respectively. The subscripts f denotes the microscopic fiber. S denotes the shear failure strength in each direction, and i, j=X, Y, Z.

To simulate the real failure behavior of fiber in dynamic drilling condition more accurately, the continuous degradation law for fiber tension and compression are considered by

$${d}_{f}^{T ( C )} = \frac{{ε}_{f , 1}^{T ( C )}}{{ε}_{f , 1}^{T ( C )} - {ε}_{0 , 1}^{T ( C )}} ( 1 - \frac{{ε}_{0 , 1}^{T ( C )}}{{ε}_{11}} ) \qquad ( 10 )$$

Where d_{f}^{T(C)} denotes the damage coefficient of each reference points of fiber in RVE model. ε_{f,1}^{T(C)} denotes the critical failure strains when the damage variables reach one. ε₁₁ denotes the real strain. ε_{0,1}^{T(C)} denotes the initial strain.

The equations which is used to obtain the damage variable are written by

$${ε}_{f , 1}^{T ( C )} = \frac{2 {Γ}_{f}^{T ( C )}}{{X}_{f}^{T ( C )} L} \qquad ( 14 )$$

$${ε}_{0 , 1}^{T ( C )} = \frac{{X}_{f}^{T ( C )}}{{E}_{f 1}} \qquad ( 15 )$$

Where in Eq. (14) and Eq. (15), Γ_{f}^{T} denotes the critical failure strain by regularizing the fiber fracture energy, and L denotes the characteristic length of microscopic element.

Due to the hexahedral element type is adopted in this study, and elements that may be damaged have the same in-plane length, thus the equation is written by

$$L = \sqrt{\frac{{( {L}_{initial} )}^{3}}{{l}_{z}}} \qquad ( 16 )$$

Where Lᵢₙᵢₜᵢₐₗ denotes the characteristic length of an element, l_{z} denotes the dimension in the thickness direction of an element as shown in Error! Reference source not found. (a).

For the tension case, fibers are completely failure in direction X if the damage coefficient d_{f}^{T} reach 1. For the compression case, the elements are considered to exist some residual loading capacity.

The fiber constitutive relationship at microscale is expressed as follows:

$$\{ \begin{matrix}{σ}_{f} = ( 1 - {d}_{f}^{T ( C )} ) {C}_{f} {ε}_{f} \\ {E}_{f 1}^{d , T ( C )} = ( 1 - {d}_{f}^{T ( C )} ) {E}_{f 1} \\ {E}_{f 2}^{d , T ( C )} = ( 1 - {d}_{f}^{T ( C )} ) {E}_{f 2}\end{matrix} \qquad ( 17 )$$

Where σ_{f}, C_{f} and ε_{f} denote the microscopic stresses, intact stiffness and microscopic strains for fiber, respectively. E_{f1}^{d,T(C)} and E_{f2}^{d,T(C)} denote the longitudinal and transverse damaged fiber elastic modulus at microscopic, respectively. E_{f1} and E_{f2} denote the initial fiber elastic modulus at microscopic, respectively.

A modified Von Mises yield criterion is used to predict the tensile and compressive failure criterion of matrix in this study, which is shown in Error! Reference source not found. (b), and the equation is written as follows:

$$\frac{{σ}_{V M}^{2} + {I}_{1} ( {C}_{m i} - {T}_{m i} )}{{C}_{m i} {T}_{m i}} = 1 \qquad ( 18 )$$

Where Tₘᵢ and Cₘᵢ denote the initial tensile strength and compression strength, respectively. σ_{VM} and I₁ denote equivalent stress and first stress invariants, respectively, these equations could be written by

$$\{ \begin{matrix}{σ}_{V M} = \sqrt{\begin{matrix}\frac{1}{2} [ {( {σ}_{m 1} - {σ}_{m 2} )}^{2} + {( {σ}_{m 2} - {σ}_{m 3} )}^{2} + \\ {( {σ}_{m 1} - {σ}_{m 3} )}^{2} + 3 ( {σ}_{m 4}^{2} + {σ}_{m 5}^{2} + {σ}_{m 6}^{2} ) ]\end{matrix}} \\ {I}_{1} = {σ}_{m 1} + {σ}_{m 2} + {σ}_{m 3}\end{matrix} \qquad ( 19 )$$

Where σₘᵢ denotes the principal stress (i=1˜3) and shear stress (i=4˜6) of matrix at microscopic.

Due to there is a great difference between tensile strength and compression strength, an equivalent stress σ_{eq} called the Stassi's stress is adopted to define the matrix damage evolution.

$${σ}_{e q} = \frac{( β - 1 ) {I}_{{1}^{+}} \sqrt{{( β - 1 )}^{2} {I}_{1}^{2} + 4 β {σ}_{V M}^{2}}}{2 β} \qquad ( 20 )$$

Where β is denotes as the ratio of the matrix initial compressive to initial tensile strength.

The value of matrix damage coefficient is determined by the stress state, which varies between 0 and 1. In RVE, the damage evolution law and the equivalent stress of the matrix could be expressed as follows:

$${\overline{d}}_{m}^{T ( C )} = \frac{\overline{κ} γ}{{T}_{m i}} ( 1 - {d}_{m}^{T ( C )} ) \qquad ( 21 )$$

$$f ( {σ}_{e q} , {κ}_{m} ) = {σ}_{e q} - {κ}_{m} \qquad ( 22 )$$

Where dₘ^{T(C)} denotes the matrix damage coefficient which is obtained by the reference points in RVE. γ denotes a parameter used to calibrate the uniaxial stress-strain curves based on test data. κₘ denotes a scalar history variable, defined as the ratio of σ_{eq} to Tₘᵢ. The determination and update of the initial damage are required by the Kuhn-Tucker loading-unload condition, namely:

f≤0, \dot{κ}ₘ≥0, f\dot{κ}ₘ=0 (20)

Then, the matrix damage coefficient in tensile and compression are expressed as

$${d}_{m}^{T ( C )} = 1 - exp [ γ ( 1 - \frac{{σ}_{e q}}{{T}_{m i}} ) ] \qquad ( 23 )$$

Under the consideration that the damage initial and evolution laws are isotropic, the constitutive relationship of the matrix by considering the degradation of the stiffness at microscopic is shown in Error! Reference source not found, and the entire equation is given as

$$\{ \begin{matrix}{σ}_{m} = ( 1 - {d}_{m}^{T ( C )} ) {C}_{m} {ε}_{m} \\ {E}_{m}^{T ( C )} = ( 1 - {d}_{m}^{T ( C )} ) {E}_{m}\end{matrix} \qquad ( 24 )$$

Where σₘ, Cₘ and εₘ denote the stress, stiffness and strain of matrix at microscopic, respectively. Eₘ^{T(C)} and Eₘ denote the damaged and initial elastic modulus of matrix at microscopic, respectively.

The macroscopic damage-constitutive stiffness matrix for CFRPs is updated according to reference when damage occurs, which is written as

$${C}_{ij}^{d} = [ \begin{matrix}( 1 - {d}_{L} ) {C}_{11}^{0} & ( 1 - {d}_{L} ) ( 1 - {d}_{T} ) {C}_{12}^{0} & ( 1 - {d}_{L} ) {C}_{13}^{0} \\ ( 1 - {d}_{L} ) ( 1 - {d}_{T} ) {C}_{12}^{0} & ( 1 - {d}_{T} ) {C}_{22}^{0} & ( 1 - {d}_{T} ) {C}_{23}^{0} \\ ( 1 - {d}_{L} ) {C}_{13}^{0} & ( 1 - {d}_{T} ) {C}_{23}^{0} & {C}_{33}^{0} \\ 0 & 0 & 0 \\ 0 & 0 & 0 \\ 0 & 0 & 0\end{matrix} \\ \begin{matrix}0 & 0 & 0 \\ 0 & 0 & 0 \\ 0 & 0 & 0 \\ ( 1 - {d}_{t} ) {C}_{44}^{0} & 0 & 0 \\ 0 & ( 1 - {d}_{L} ) {C}_{55}^{0} & 0 \\ 0 & 0 & ( 1 - {d}_{L} ) ( 1 - {d}_{T} ) {C}_{66}^{0}\end{matrix} ] \qquad ( 25 )$$

Where d_{L} and d_{T} denote the longitudinal and transverse macroscopic damage variables of CFRPs laminate, respectively. Cᵢⱼ⁰ (i, j=1˜6) denotes the undamaged macroscopic stiffness coefficient for CFRPs laminate, and the variable equations are written as

$$( 26 )$$

$$\{ \begin{matrix}\begin{matrix}{C}_{11}^{0} = \frac{{E}_{1} ( 1 - {v}_{23} {v}_{32} )}{Λ} & {C}_{12}^{0} = \frac{{E}_{2} ( 1 - {v}_{13} {v}_{32} )}{Λ} & {C}_{11}^{0} = \frac{{E}_{3} ( {v}_{13} - {v}_{12} {v}_{23} )}{Λ} \\ {C}_{22}^{0} = \frac{{E}_{2} ( 1 - {v}_{13} {v}_{31} )}{Λ} & {C}_{23}^{0} = \frac{{E}_{3} ( {v}_{23} - {v}_{21} {v}_{31} )}{Λ} & {C}_{33}^{0} = \frac{{E}_{3} ( 1 - {v}_{12} {v}_{21} )}{Λ} \\ {C}_{44}^{0} Λ {G}_{23} & {C}_{55}^{0} Λ {G}_{13} & {C}_{66}^{0} Λ {G}_{12} \\ & & \end{matrix} \\ Λ = 1 - {v}_{12} {v}_{21} - {v}_{23} {v}_{32} - {v}_{31} {v}_{13} - 2 {v}_{12} {v}_{23} {v}_{31}\end{matrix}$$

Where Eᵢ, vᵢⱼ and Gᵢⱼ (i,j=1,2,3) denote the macroscopic elastic modulus, Poisson's ratio, macroscopic shear modulus of CFRPs, respectively.

The macroscopic damage variables are directly evaluated by the degraded elastic parameters of the microscopic constituents computed from RVE via the mixture rule, which is given as

$$\begin{matrix}\{ \begin{matrix}{d}_{L}^{T ( C )} = 1 - \frac{( {E}_{f 1}^{d , T ( C )} {V}_{f} + {E}_{m}^{d , T ( C )} {V}_{m} )}{{E}_{1}} \\ {d}_{T}^{T ( C )} = 1 - \frac{[ \begin{matrix}( 1 - C ) \frac{{E}_{f 2}^{d , T ( C )} {E}_{m}}{{E}_{f 2}^{d , T ( C )} {V}_{m} + {E}_{m}^{d , T ( C )} {V}_{f}} \\ + C ( {E}_{f 2}^{d , T ( C )} {V}_{f} + {E}_{m}^{d , T ( C )} {V}_{m} )\end{matrix} ]}{{E}_{2}} \\ C = 0.2 ( {V}_{f} - {V}_{m} ) + 0.175\end{matrix} & ( 27 ) \\ \{ \begin{matrix}{d}_{L} = 1 - ( 1 - {d}_{L}^{T} ) ( 1 - {d}_{L}^{C} ) \\ {d}_{T} = 1 - ( 1 - {d}_{T}^{T} ) ( 1 - {d}_{T}^{C} )\end{matrix} & ( 28 )\end{matrix}$$

Where V_{f} and Vₘ denote the fiber volume fraction and matrix volume fraction of CFRPs, respectively.

In order to prevent non-convergence in the calculation due to the occurrence of severely distorted elements in the finite element software, this paper introduces the maximum principal strain and minimum principal strain criteria to realize the auxiliary deletion of excessively distorted elements. Based on the polar decomposition theorem, the motion of any object is It can be decomposed into pure stretching and pure rigid body rotation in three directions, namely:

$$\{ \begin{matrix}\tilde{F} = \tilde{V} \cdot \tilde{R} \\ \tilde{F} = \frac{\partial x}{\partial \overline{X}}\end{matrix} \qquad ( 29 )$$

\tilde{F} represents the strain gradient matrix; \tilde{V} represents the pure tensile deformation of the material; \tilde{R} represents the pure rigid body rotation of the material; \tilde{X} and \tilde{x} represent the initial position and the deformed position of the micro-element, respectively.

The laminated plate models of the composite materials in this application all adopt the hexahedral element model, and the characteristic roots of the \tilde{V} matrix are solved, and the main stretching ratios of the three directions of the element λ₁, λ₂, λ₃ can be obtained, which are respectively calculated according to the definition of Biot strain (nominal strain) 3 principal strains.

εᵢ=λᵢ−1 (30)

εᵢ (i=1,2,3) represents the principal strain of the element; λᵢ (i=1,2,3) represents the principal stretch ratio of the element.

According to the computed principal strain value of each element, the auxiliary element deletion criterion can be expressed as

$$\{ \begin{matrix}{ɛ}_{i}^{max} - {ɛ}_{i}^{max , s} \geq 0 & failure \\ {ɛ}_{i}^{max} - {ɛ}_{i}^{max , s} < 0 & no failure \\ {ɛ}_{i}^{min} - {ɛ}_{i}^{min , s} \geq 0 & failure \\ {ɛ}_{i}^{min} - {ɛ}_{i}^{min , s} < 0 & no failure\end{matrix} \qquad ( 31 )$$

In Eq. (31), εₚ^{max} and εₚ^{min} denote the maximum and minimum principal strain of the failure elements, respectively, εₚ^{max,s} and εₚ^{min,s} denote the pre-set value of the maximum and minimum principal strain according to educated estimation, respectively. εₒ^{max,s}=1.0 and εₒ^{min,s}=0.8 are adopted in this study.

A detailed algorithm flowchart of the logic in the implementation of VUMAT is shown in Error! Reference source not found. The procedure of span-scale numerical implementation is mainly divided into three steps.

Step (1): At the beginning of the n th step, calculate the total global strain ε̅ⁿ via adding the previous time strain ε̅ⁿ⁻¹ and the global strain increment Δε̅ⁿ. The macroscopic stress for each integration point σ̅ⁿ is computed by the UD-CFRPs laminate stiffness matrix Cᵢⱼ^{n-1,d} stored at the (n−1) th step.

Step (2): The microscopic stresses in fiber and matrix are calculated by multiplying the SAFs of the fiber M_{fσ}^{n,pk} and matrix M_{mσ}^{n,pk} for all the pre-set reference points, respectively. Then apply the modified MMF criterion for the fiber and matrix to judge their failure factor, respectively. The 3D dynamic progressive damage model is employed to gain the damage variables for fiber and matrix. The maximum values of d_{f}^{n,T(C)} and dₘ^{n,T(C)} for all pre-set reference points are defined for the fiber and matrix damage coefficient of the RVE at microscopic, respectively.

Step (3): Based on the established damage evolution model, the damage variables at macroscale for each integration point could be computed via the maximum values of d_{f}^{n,T(C)} and dₘ^{n,T(C)} to realize the stiffness degradation of elements. Larger value of the macroscopic damage variables at the nth step are chosen by comparing with that at the (n−1) step since they are irreversible. After that, the failure element deletion auxiliary criterion is added to implement the serious distortion element deletion in order to prevent nonconvergence in the calculation. Then the damaged UD-CFRPs laminate stiffness matrix Cᵢⱼ^{n,d} is re-calculated and updated to determine whether the element is required to be deleted or not. The procedure will end if the pre-set time increments is reached.

The initial and damage constitutive expression can be written as

$$\{ \begin{matrix}{T}_{m} = {K}_{i} {δ}_{m} , & {δ}_{m}^{max} \leq {δ}_{m}^{0} \\ {T}_{m} = ( 1 - {D}_{mix}^{s} ) {K}_{i} {δ}_{m} , & {δ}_{m}^{0} \leq {δ}_{m}^{max} < {δ}_{m}^{f} \\ {T}_{m} = 0 , & {δ}_{m}^{max} \geq {δ}_{m}^{f}\end{matrix} \qquad ( 30 )$$

Where Tₘ denotes the mixed-mode nominal stress. Kᵢ (i=n, s, t denotes the mode N, model S and model T delamination, respectively) denotes the constitutive stiffness of CEs. Dₘᵢₓ^{s} denotes the mixed-mode damage variables of the CEs. δᵢ denotes the mixed-mode displacement. δₘ^{max} denotes the maximum value of the mixed-mode displacement. δₘ⁰ denotes the effective displacement at the damage initiation. δₘ^{f} denotes the mixed-mode displacement at complete failure. Each expression can be written as follows:

$$\begin{matrix}{D}_{mix}^{s} = \frac{{δ}_{m}^{f} ( {δ}_{m}^{max} - {δ}_{m}^{0} )}{{δ}_{m}^{max} ( {δ}_{m}^{f} - {δ}_{m}^{0} )} & ( 31 ) \\ \{ \begin{matrix}{δ}_{m}^{max} = max ( {δ}_{m}^{max} , {δ}_{m} ) \\ {δ}_{m} = \sqrt{{δ}_{n}^{2} + {δ}_{s}^{2} + 〈 {δ}_{t}^{2} 〉}\end{matrix} & ( 32 ) \\ {δ}_{m}^{0} = \{ \begin{matrix}{δ}_{t}^{0} {δ}_{n}^{0} \sqrt{\frac{1 + {β}^{2}}{{( {δ}_{2}^{0} )}^{2} + {( {βδ}_{t}^{0} )}^{2}}} & {δ}_{t} > 0 \\ \sqrt{{( {δ}_{n}^{0} )}^{2} + {( {δ}_{s}^{2} )}^{2}} & {δ}_{t} \leq 0\end{matrix} & ( 33 ) \\ {δ}_{m}^{f} = \{ \begin{matrix}\frac{2}{{K}_{i} {δ}_{m}^{0}} [ {G}_{Tn} + ( {G}_{Ts} - {G}_{Tn} ) {( \frac{{β}^{2}}{1 + {β}^{2}} )}^{η} ] & {δ}_{t} > 0 \\ \sqrt{{( {δ}_{n}^{0} )}^{2} + {( {δ}_{s}^{0} )}^{2}} & {δ}_{t} \leq 0\end{matrix} & ( 32 )\end{matrix}$$

Where in Eq. (32), Eq. (33) and Eq. (32), <●> denotes the MacAuley bracket. δₙ, δₛ, δₜ denote the displacement in different directions (n denotes normal direction, s denotes the first shear direction and t denotes the second shear direction), respectively.) β denotes the mode mixing ratio, and it can be written as

$$β = \sqrt{\frac{( {δ}_{n}^{2} + {δ}_{s}^{2} )}{{δ}_{t}^{2}}} {δ}_{t} > 0 \qquad ( 33 )$$

Where η denotes the parameter defined in the Benzeggagh-Kenane fracture energy law, and η=1.45 is adopted due to CFRPs being the research object. G_{Tn} and G_{Ts} denote the interlaminar fracture energy in mode N and mode S, respectively. (Mode N and mode S denote crack when the upper and lower surfaces of elements are subject to opposite normal and tangential force displacement, respectively. In addition, Turon et al suggested that the CEs zone length is chosen as approximately 2-3 element side length, which is apply for regularizing the delamination fracture toughness for the sake of eliminating the mesh sensitivity.

The relationship between actual stress and maximum stress can be expressed as

σ=(1−D^{s})σ̅ (36)

In the calculation process of the finite element software, if the damage variable D^{s} at the cross-section integration point of a cohesive element reaches Dₘₐₓ^{s}, the element will be deleted. The dimensionless stiffness degradation coefficient SDEG in the ABAQUS software and the damage variable D^{s} in the model have the same meaning, that is, when SDEG=1, the unit is judged to be invalid and deleted.

The material properties of fiber and matrix are shown in Tab. 1.

TABLE 1
Material parameters of fiber and matrix

| Fiber | | | | Matrix | |
|---|---|---|---|---|---|
| E_{f1}(GPa) | 230 | X_{f}^{T}/X_{f}^{C} | 4.9/4.5 | Eₘ(GPa) | 2.9 |
| | | (MPa) | | | |
| E_{f2}/E_{f3}(GPa) | 15 | Y_{f}^{T}/Y_{f}^{C} | 40.0/70.0 | vₘ | 0.34 |
| | | (MPa) | | | |
| v_{f12}/v_{f13} | 0.21 | Z_{f}^{T}/Z_{f}^{C} | 40.0/70.0 | Gₘ(GPa) | 1.31 |
| | | (MPa) | | | |
| v_{f23} | 0.307 | S_{f}^{XY}/S_{f}^{XZ} | 100.0/100.0 | Tₘᵢ(MPa) | 80.0 |
| | | (MPa) | | | |
| G_{f12}/G_{f13}(GPa) | 9 | S_{f}^{YZ} | 58.0 | Cₘᵢ(MPa) | 120.0 |
| | | (MPa) | | | |
| G_{f23}(GPa) | 5.03 | Γ_{f}^{T}/Γ_{f}^{C} | 100.0 | γ | 1.5 |
| | | (N/mm) | | | |

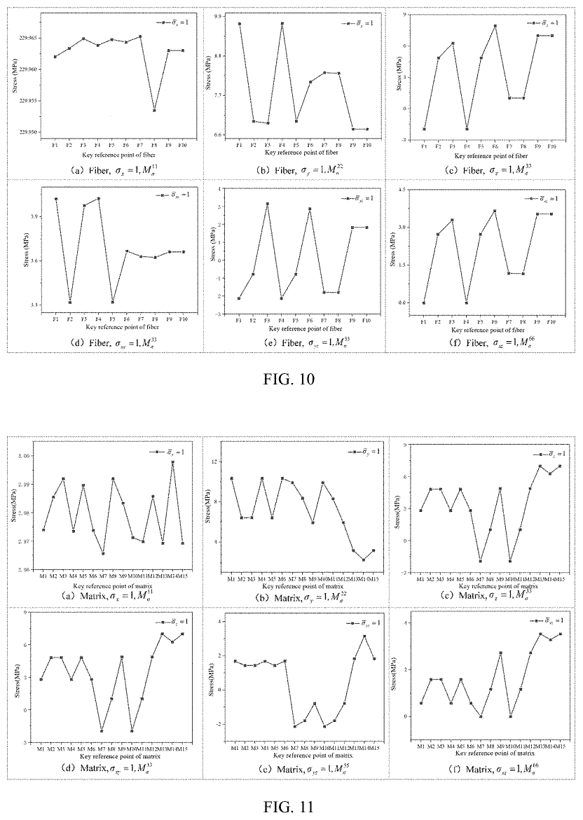

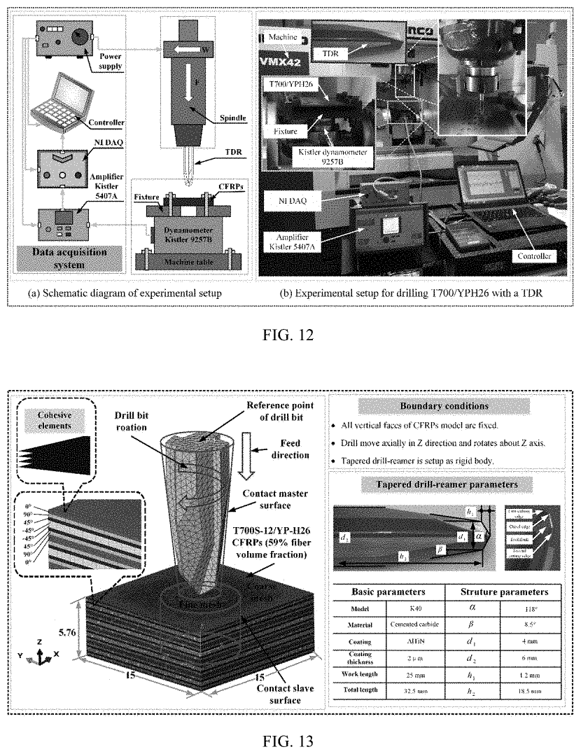

When the representative volume element model is meshed, the position and number of the element nodes set on each symmetry plane should be kept completely consistent, and the mesh should be generated by mapping, as shown in FIG. 9(a). In order to avoid over-constrained mesh nodes on the vertices and edges in the representative volume element model, when applying periodic boundary conditions to the node set, the vertices and nodes on the edges must be removed from the surface, and the vertices must be removed at the same time. The node on is removed from the edge, a vertex contains only one node, but each node set on all faces and edges can contain multiple nodes at the same time.

In the global coordinate system, the side lengths of the representative volume element model established are defined as Wₓ, W_{y}, and h. The coordinate origin is located at D. Under six kinds of macro stress loads (εₓ⁰, ε_{y}⁰, ε_{z}⁰, ε_{xy}⁰, ε_{xz}⁰, ε_{yz}⁰), the period established according to formula (4) Under nonlinear boundary conditions, the following linear constraint equations are used to realize the loading of vertices, edges and planes in response to load conditions.

In the ABAQUS/Standard analysis step, the representative volume element model is respectively applied to each unit stress load under six working conditions (triaxial macroscopic tension and shear) to obtain the microscopic stress distribution, as shown in FIG. 10. 10 red solid circles are used to represent the key reference points of micro-fibers and 15 purple solid circles are used to represent the stress magnification factor calculated from the reference points of the micro-matrix of the matrix, as shown in FIG. 2. The F10 reference point and the M10˜M15 points are located at the center of the fiber and the center of the matrix, respectively. F1˜F9 reference points and M1˜M9 consider the key reference points of the position where the fiber and the matrix join. Since the external stress load is 1 MPa, the microscopic stress distribution of each key reference point is the stress amplification factor. The stress of each key reference point on the fiber and matrix under different working conditions is shown in FIG. 10 and FIG. 11. Show. Since the inherent properties of the material will not change, the representative volume element model only needs to be solved once and the key reference point results are extracted. After obtaining the stress amplification factor, store it in a separate file in the Fortran code. In the macro composite drilling finite element model, use the “#include” function to call the file based on the ABAQUS VUMAT code to realize the dynamics of the composite material. Multi-scale analysis of progressive failure.

High temperature-resistant CFRPs (T700S-12K/YP-H26) are used as the research object in the FE modeling. The fiber volume fraction is approximately 59%, and the layup sequence of the CFRPs is [(0°/90°/45°/−45°)s]₂. Orthotropic material property was assigned to each UD-CFRPs laminate according to the fiber orientation by using a predefined local coordinate system. The CEs, which is modeled as having a thickness 0 mm, was used for simulating the delamination phenomenon. The materials parameters of UD-CFRPs laminate elements and cohesive-zone elements are reported in Tab. 2 and Tab. 3, respectively.

TABLE 2
Material parameters used to model unidirectional
CFRPs laminate elements

| | Value | Strength | Value |
|---|---|---|---|
| Elastic parameters | (GPa) | parameters | (GPa) |
| E₁ | 138.7 | X^{T}/X^{C} | 1870/1026 |
| E₂ = E₃ | 7.04 | Y^{T}/Y^{C} | 45/156 |
| v₁₂ = v₁₃ | 0.25 | Z^{T}/Z^{C} | 40/145 |
| v₂₃ | 0.31 | S_{XY} | 87 |
| G₁₂ = G₁₃ | 2.959 | S_{XZ} | 87 |
| G₂₃ | 2.505 | S_{YZ} | 58 |

TABLE 3
Material parameters used to model interface CEs

| | Value | Strength | Value | Fraction | Value |
|---|---|---|---|---|---|
| Stiffness | (N/mm³) | parameters | (MPa) | energy | (N/mm) |
| Kₙ | 4 × 10⁶ | δₙ | 60 | Gₙ | 0.2 |
| Kₛ = Kₜ | 1 × 10⁶ | δₛ = δₜ | 90 | Gₛ = Gₜ | 1 |

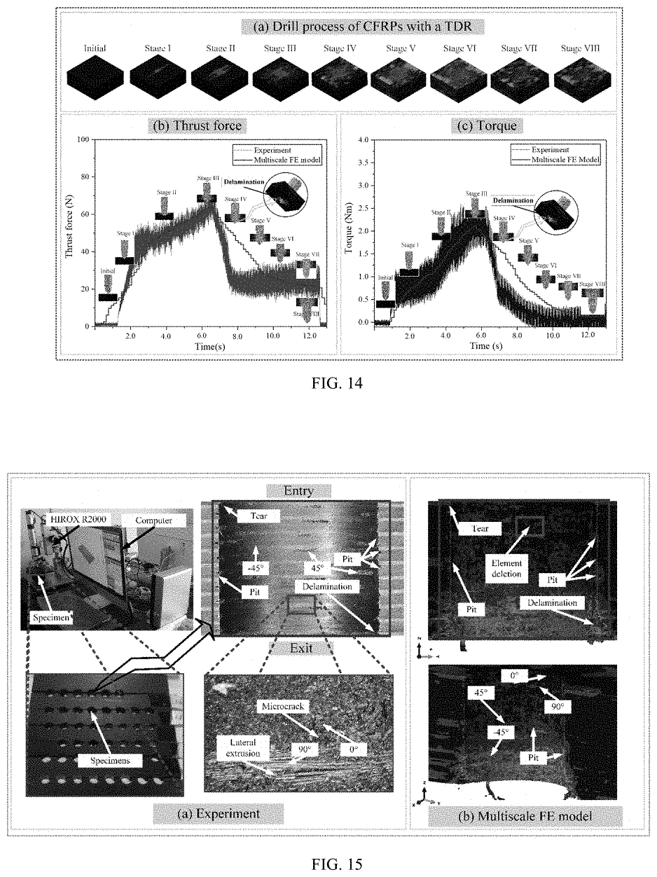

According to the actual working conditions of the drill bit feeding the composite material along the axial direction, boundary conditions such as speed and feed rate are applied to the entire drilling finite element model. Since the motion state of the dagger drill model is constrained at the top reference point, the reference point is The displacement in the X and Y directions is limited, and the feed speed is applied in the Z direction. Similarly, the rotation speed in the X and Y directions is limited, and the clockwise rotation speed is applied in the Z direction, and the composite material layer The four vertical surfaces of the plywood are fixed. After the simulation calculation is completed, this application verifies the model through an experimental platform built. The experimental platform mainly includes three systems: CFRP drilling, data acquisition, and experimental observation. The schematic diagram of the experimental plan and the connection of the test device are shown in FIG. 13.

According to the comparative analysis results of experiment and simulation shown in FIG. 14, the axial force and torque of the drilling multi-scale finite element model and experiment have the same value and change trend at each stage of drilling, only in the T_{IV} and T_{V} stages. Compared with the experiment, the reduction speed of axial force and torque is slower. The main reason is that the fiber adopts the degradation method based on fracture toughness in the multi-scale finite element model. The set dissipation energy value is obtained based on empirical evaluation. Due to the effect of the CEs in the bonding area in the simulation of the interlayer delamination phenomenon, some macro-units in the model are not deleted, which leads to too long contact time between the unit and the drill bit, which in turn generates some small forces and torques.

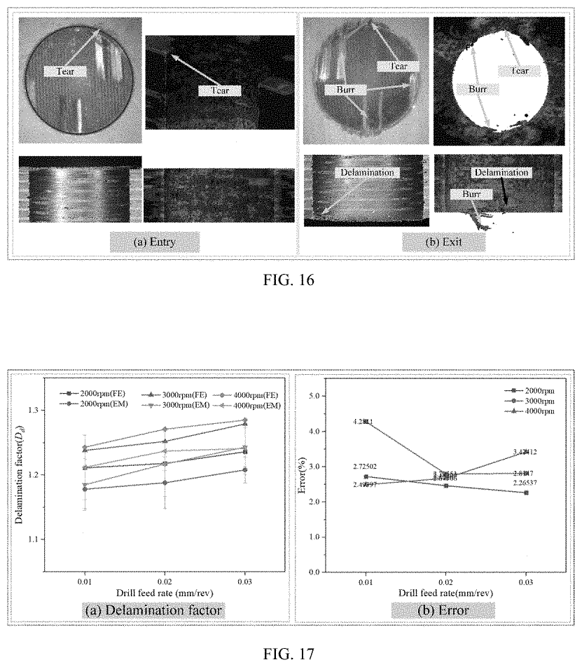

It can be clearly observed from FIG. 15(a) that the CFRP pore wall is mainly composed of resin-coated surface and fiber fracture surface, and the pore wall coating surface near the entrance is more obvious. The damage of CFRP from the entrance to the exit of drilling is mainly manifested as damages such as splitting at the entrance, tearing at the exit, burrs, separation between layers, radial crushing, and microcracks. According to the comparative analysis of the damage position of each layer in FIGS. 15(a) and (b), it is found that the pits and the hole wall damage positions are almost the same. Therefore, the multi-scale finite element model established in this paper can simulate the damage state of the CFRP drilling hole wall more realistically.

CFRP is prone to burrs, tearing, delamination and other processing damages at the entrance and exit during the process of making holes. Because the dagger drill is a special CFRP drill with integrated drilling and reaming, only the fiber fracture at the entrance of the hole when drilling the CFRP laminate It is relatively flat, the entrance tearing phenomenon is not obvious and there are fewer burrs, but through the finite element analysis model and test results, there are more obvious burrs, tears, and delamination damage at the exit, as shown in FIG. 16(a) . However, because the multi-scale finite element model is based on the deletion of macroscopic elements to realize the simulation of material removal, the scale effect of the element can only simulate the damage phenomenon at the macro level, and cannot achieve the quantification of burrs and tear damage. The delamination damage in CFRP holes generally only exists between a few layers of material on the side of the exit. The size of the internal damage needs to be observed with observation equipment such as ultrasonic scanning, but the delamination at the exit will follow the direction of the dagger drilling Extending to the outside of the material, there is a part of the height of the bulge in the damaged area, which only needs to be observed with a super-depth microscope, as shown in FIG. 16(a).

The delamination damage system is based on the tool diameter. The area calculated by the number of deleted elements around the hole is divided by the area of the reference hole to calculate the delamination damage coefficient. The measurement method is to export the picture in the ABAQUS software, and then import it into the CAD software. The belt tool adopts the equal proportion method to realize the measurement respectively. Since the rotation speed of the drill bit is too fast under actual working conditions, and the deletion of the multi-scale finite element model unit is irrecoverable, the area of the damaged unit in the center of the layered area is used to calculate the layered damage coefficient, as shown in FIG. 24(b) Shown. Therefore, the delamination damage coefficient can be expressed as

$${D}_{d} = ( \frac{{A}_{d}}{{A}_{nom}} ) \% \qquad ( 34 )$$

Where D_{d} denotes the delamination factor, A_{d} denotes nominal diameter, and Aₘₐₓ denotes the delamination areas. The delamination damage coefficient at the exit of the drilling CFRP under different processing parameters in the multi-scale finite element model and test conditions is calculated. It can be seen from FIG. 17 that the finite element model and the test results are relatively close to the results of the damage coefficient analysis. At the same time, the change trend of the machining parameters also tends to be consistent with the change of the machining parameters.

In summary, the multi-scale finite element model established in this paper can truly simulate the CFRP damage state under actual working conditions. The maximum errors of axial force, torque, and outlet delamination damage coefficient are 3.37%, 7.69%, and 4.28%, respectively. At the same time, it can also simulate the phenomenon of hole wall surface damage and exit delamination more realistically.

What is claimed is:

1. A dynamic progressive failure analysis method based on multi-scale model of composite material is proposed as follows:
In the first step, ignoring the initial damage of composite laminates in the process of fabrication, the composite is idealized as the superposition of the preset stacking sequence of unidirectional laminates, and the macro structure of the composite is analyzed, considering the influence of macro structure design, material properties, stacking method and loading form of the whole structure on the internal stress and strain distribution of the structure;
In the second step, according to the mechanical analysis of unidirectional laminates, the fiber distribution of unidirectional laminates is reasonably simplified;
Based on the fiber volume fraction, a representative volume element of micromechanics oriented to the apparent mechanical properties of composite structures is established, and the multi-scale analysis method is used to transfer the load of macro structural elements or integral points to the micro model, Under this load, the stress distribution of each element integral point of fiber and matrix component material is simulated; In addition, the micro failure theory is used to judge the failure of the matrix and fiber respectively; Assuming that each corresponding element is damaged, the stiffness of the damaged element is reduced and the failure element is deleted until it is deleted; If the element is not deleted, the whole cell model is homogenized to obtain the macro mechanical properties of the damaged material;
In the third step, the macro properties of the damaged material are assigned to the corresponding elements in the macro structure, and then the macro analysis of the whole structure is carried out in the next step, which is repeated until the set time analysis step is completed; Finally, the multi-scale numerical simulation analysis of the composite material from the component to the structure under the cutting action of the cutting tool is realized.

2. The method according to claim 1, which is characterized in that the macro stress of the composite laminate structure and the micro stress of each component structure are bridged by the stress amplification factor, and the stress amplification factor can be obtained by the finite element analysis results of representative volume elements including fiber and matrix.

3. The method according to claim 1, which is characterized by comprising the following finite element algorithm:
In the first step: At the beginning of the n th step, calculate the total global strain ε̅ⁿ via adding the previous time strain ε̅ⁿ⁻¹ and the global strain increment Δε̅ⁿ; The macroscopic stress for each integration point σ̅ⁿ is computed by the UD-CFRPs laminate stiffness matrix Cᵢⱼ^{n-1,d} stored at the (n−1) th step;
In the second step: The microscopic stresses in fiber and matrix are calculated by multiplying the SAFs of the fiber M_{fσ}^{n,pk} and matrix M_{mσ}^{n,pk} for all the pre-set reference points, respectively; Then apply the modified MMF criterion for the fiber and matrix to judge their failure factor, respectively; The 3D dynamic progressive damage model is employed to gain the damage variables for fiber and matrix; The maximum values of d_{f}^{n,T(C)} and dₘ^{n,T(C)} for all pre-set reference points are defined for the fiber and matrix damage coefficient of the RVE at microscopic, respectively;
In the third step: Based on the established damage evolution model, the damage variables at macroscale for each integration point could be computed via the maximum values of d_{f}^{n,T(C)} and dₘ^{n,T(C)} to realize the stiffness degradation of elements; Larger value of the macroscopic damage variables at the nth step are chosen by comparing with that at the n−1 step since they are irreversible; After that, the failure element deletion auxiliary criterion is added to implement the serious distortion element deletion in order to prevent nonconvergence in the calculation; Then the damaged UD-CFRPs laminate stiffness matrix Cᵢⱼ^{n,d} is re-calculated and updated to determine whether the element is required to be deleted or not; The procedure will end if the pre-set time increments is reached.

4. the method according to claim 1, which is characterized in that the expression of macro micro transformation equation is shown in formula (1), (2) and (3):
$$\begin{matrix}{σ}_{i} = {M}_{σ}^{pk ( n )} {\overline{σ}}_{j} & ( 1 ) \\ \{ \begin{matrix}{σ}_{i} = [ \begin{matrix}{σ}_{1} & {σ}_{2} & {σ}_{3} & {σ}_{4} & {σ}_{5} & {{σ}_{6} ]}^{T}\end{matrix} \\ {\overline{σ}}_{j} = [ \begin{matrix}{\overline{σ}}_{1} & {\overline{σ}}_{2} & {\overline{σ}}_{3} & {\overline{σ}}_{4} & {\overline{σ}}_{5} & {{\overline{σ}}_{6} ]}^{T}\end{matrix}\end{matrix} & ( 2 ) \\ {M}_{σ}^{pk ( n )} = {[ \begin{matrix}{M}_{σ}^{11} & {M}_{σ}^{12} & {M}_{σ}^{13} & {M}_{σ}^{14} & {M}_{σ}^{15} & {M}_{σ}^{16} \\ {M}_{σ}^{21} & {M}_{σ}^{22} & {M}_{σ}^{23} & {M}_{σ}^{24} & {M}_{σ}^{25} & {M}_{σ}^{26} \\ {M}_{σ}^{31} & {M}_{σ}^{32} & {M}_{σ}^{33} & {M}_{σ}^{33} & {M}_{σ}^{34} & {M}_{σ}^{35} \\ {M}_{σ}^{41} & {M}_{σ}^{42} & {M}_{σ}^{43} & {M}_{σ}^{44} & {M}_{σ}^{45} & {M}_{σ}^{46} \\ {M}_{σ}^{51} & {M}_{σ}^{52} & {M}_{σ}^{53} & {M}_{σ}^{54} & {M}_{σ}^{55} & {M}_{σ}^{56} \\ {M}_{σ}^{61} & {M}_{σ}^{62} & {M}_{σ}^{63} & {M}_{σ}^{64} & {M}_{σ}^{65} & {M}_{σ}^{66}\end{matrix} ]}^{( i )} & ( 3 )\end{matrix}$$
Where in Eq. (1)-(3), “σᵢ” denotes the microscopic stress at point n of fiber or matrix, “n” denotes the number of the pre-set reference point, i=1˜6; “σ̅ⱼ” denotes the macroscopic stress of CFRPs laminate, j=1˜6; “M_{σ}^{pk(n)}” denotes the SAFs at point n under the mechanical loading, which establish the relationship between the macroscopic and microscopic levels, can be computed by RVE, p=1˜6, k=1˜6.

5. The method according to claim 1, which is characterized in that the equation for calculating the element characteristic length can be expressed as follows:
$$L = \sqrt{\frac{{( {L}_{initial} )}^{3}}{{i}_{z}}} \qquad ( 4 )$$
Where “Lᵢₙᵢₜᵢₐₗ” denotes the characteristic length of an element, In the material subroutine, “charlength” function is embedded in VUMAT; “l_{z}” denotes the dimension in the thickness direction of an element.

6. The dynamic progressive failure analysis method of composite multi-scale model according to claim 1, which is characterized in that in order to prevent non convergence in calculation due to severe distortion elements in the finite element software, the application introduces the maximum principal strain and minimum principal strain criteria to realize auxiliary deletion of excessive distortion elements, and is based on the polar decomposition theorem, The motion of any object can be decomposed into pure stretching and pure rigid body rotation in three directions:
$$\{ \begin{matrix}\tilde{F} = \tilde{V} \cdot \tilde{R} \\ \tilde{F} = \frac{\partial x}{\partial \overline{X}}\end{matrix} \qquad ( 5 )$$
“\tilde{F}” represents the strain gradient matrix; “\tilde{V}” represents the pure tensile deformation of the material; “\tilde{R}” represents the pure rigid body rotation of the material; “\tilde{X}” and “x̅” represent the initial position and the deformed position of the micro-element, respectively;
The macroscopic damage-constitutive stiffness matrix for CFRPs is updated according to reference when damage occurs, which is written as
$${C}_{ij}^{d} = [ \begin{matrix}( 1 - {d}_{L} ) {C}_{11}^{0} & ( 1 - {d}_{L} ) ( 1 - {d}_{T} ) {C}_{12}^{0} & ( 1 - {d}_{L} ) {C}_{13}^{0} \\ ( 1 - {d}_{L} ) ( 1 - {d}_{T} ) {C}_{12}^{0} & ( 1 - {d}_{T} ) {C}_{22}^{0} & ( 1 - {d}_{T} ) {C}_{23}^{0} \\ ( 1 - {d}_{L} ) {C}_{13}^{0} & ( 1 - {d}_{T} ) {C}_{23}^{0} & {C}_{33}^{0} \\ 0 & 0 & 0 \\ 0 & 0 & 0 \\ 0 & 0 & 0\end{matrix} \\ \begin{matrix}0 & 0 & 0 \\ 0 & 0 & 0 \\ 0 & 0 & 0 \\ ( 1 - {d}_{t} ) {C}_{44}^{0} & 0 & 0 \\ 0 & ( 1 - {d}_{L} ) {C}_{55}^{0} & 0 \\ 0 & 0 & ( 1 - {d}_{L} ) ( 1 - {d}_{T} ) {C}_{66}^{0}\end{matrix} ] \qquad ( 6 )$$
Where “d_{L}” and “d_{T}” denote the longitudinal and transverse macroscopic damage variables of CFRPs laminate, respectively, “Cᵢⱼ⁰” (i, j=1˜6) denotes the undamaged macroscopic stiffness coefficient for CFRPs laminate, and the variable equations are written as
$$( 7 )$$
$$\{ \begin{matrix}\begin{matrix}{C}_{11}^{0} = \frac{{E}_{1} ( 1 - {v}_{23} {v}_{32} )}{Λ} & {C}_{12}^{0} = \frac{{E}_{2} ( 1 - {v}_{13} {v}_{32} )}{Λ} & {C}_{13}^{0} = \frac{{E}_{3} ( {v}_{13} - {v}_{12} {v}_{23} )}{Λ} \\ {C}_{22}^{0} = \frac{{E}_{2} ( 1 - {v}_{13} {v}_{31} )}{Λ} & {C}_{23}^{0} = \frac{{E}_{3} ( {v}_{23} - {v}_{21} {v}_{31} )}{Λ} & {C}_{33}^{0} = \frac{{E}_{3} ( 1 - {v}_{12} {v}_{21} )}{Λ} \\ {C}_{44}^{0} Λ {G}_{23} & {C}_{55}^{0} Λ {G}_{13} & {C}_{66}^{0} Λ {G}_{12} \\ & & \end{matrix} \\ Λ = 1 - {v}_{12} {v}_{21} - {v}_{23} {v}_{32} - {v}_{31} {v}_{13} - 2 {v}_{12} {v}_{23} {v}_{31}\end{matrix}$$
Where “Eᵢ”, “vᵢⱼ” and “Gᵢⱼ” (i,j=1,2,3) denote the macroscopic elastic modulus, Poisson's ratio, macroscopic shear modulus of CFRPs, respectively;
The macroscopic damage variables are directly evaluated by the degraded elastic parameters of the microscopic constituents computed from RVE via the mixture rule, which is given as
$$\begin{matrix}\{ \begin{matrix}{d}_{L}^{T ( C )} = 1 - \frac{( {E}_{f 1}^{d , T ( C )} {V}_{f} + {E}_{m}^{d , T ( C )} {V}_{m} )}{{E}_{1}} \\ {d}_{T}^{T ( C )} = 1 - \frac{[ \begin{matrix}( 1 - C ) \frac{{E}_{f 2}^{d , T ( C )} {E}_{m}}{{E}_{f 2}^{d , T ( C )} {V}_{m} + {E}_{m}^{d , T ( C )} {V}_{f}} \\ + C ( {E}_{f 2}^{d , T ( C )} {V}_{f} + {E}_{m}^{d , T ( C )} {V}_{m} )\end{matrix} ]}{{E}_{2}} \\ C = 0.2 ( {V}_{f} - {V}_{m} ) + 0.175\end{matrix} & ( 8 ) \\ \{ \begin{matrix}{d}_{L} = 1 - ( 1 - {d}_{L}^{T} ) ( 1 - {d}_{L}^{C} ) \\ {d}_{T} = 1 - ( 1 - {d}_{T}^{T} ) ( 1 - {d}_{T}^{C} )\end{matrix} & ( 9 )\end{matrix}$$
Where “V_{f}” and “Vₘ” denote the fiber volume fraction and matrix volume fraction of CFRPs, respectively; “E_{f1}^{d,T(C)}” and “E_{f2}^{d,T(C)}” denote the longitudinal and transverse damaged fiber elastic modulus at microscopic, respectively; “E_{f1}” and “E_{f2}” denote the initial fiber elastic modulus at microscopic, respectively, “Eₘ^{d,T(C)}” indicates the damage state variable of the matrix under tensile and compression conditions.
